(19) United States
(12) Patent Application Publication
(10) Pub. No.: US 2026/0135505 A1
(43) Pub. Date: May 14, 2026

(54) ELECTRIC MACHINE, MOTOR VEHICLE, AND METHOD FOR OPERATING AN ELECTRIC MACHINE

(71) Applicant: Dr. Ing. h.c. F. Porsche Aktiengesellschaft, Stuttgart (DE)

(72) Inventor: Robin LEHNER, Frankfurt am Main (DE)

(21) Appl. No.: 19/379,821

(22) Filed: Nov. 5, 2025

(30) Foreign Application Priority Data
Nov. 13, 2024 (DE) 10 2024 133 135.6

(51) Int. Cl. H02P 27/08

(52) U.S. Cl. CPC H02P 27/08

(57) ABSTRACT

An electrical machine has a pulse inverter and is an N x M phase machine having N times M phases, with N being N >= 2 and M being M >= 3, so that M phases connected N-fold in parallel are present. The pulse inverter has half bridges with one half bridge per phase, each of the half bridges having semiconductor switches, and the N-fold connection of the M phases having N half bridges connected in parallel. At least one of the N half bridges connected in parallel is switched off or is capable of being switched off.

### CROSS REFERENCE TO RELATED APPLICATIONS

This application claims benefit to German Patent Application No. DE 102024133 135.6, filed on November 13, 2024, which is hereby incorporated by reference herein.

### FIELD

The present disclosure relates to an electric machine, a motor vehicle having an electric machine, and a method for operating an electric machine.

### BACKGROUND

In electric drives for electric vehicles, power modules of a pulse inverter connected in parallel may be implemented on a 3-phase electric machine. The total chip surface per phase provides the maximum current-carrying capacity of the pulse inverter. In some cases, the chip surface is very high, which however leads to high switching losses in the pulse inverter in the turndown range, because the entire chip surface must also be recharged in the turndown event. This is rather undesirable.

### SUMMARY

In an embodiment, the present disclosure provides an electrical machine that has a pulse inverter and is an N x M phase machine having N times M phases, with N being N >= 2 and M being M >= 3, so that M phases connected N-fold in parallel are present. The pulse inverter has half bridges with one half bridge per phase, each of the half bridges having semiconductor switches, and the N-fold connection of the M phases having N half bridges connected in parallel. At least one of the N half bridges connected in parallel is switched off or is capable of being switched off.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a schematic view of an example embodiment of an electric machine having a pulse inverter device of a motor vehicle.

### DETAILED DESCRIPTION

Aspects of the present disclosure provide a method for operating an electric machine, an electric machine, and a motor vehicle having an electric machine, wherein the aforementioned switching losses are reduced in the turndown range.

According to an exemplary aspect of the present disclosure, there is provided an electrical machine having a pulse inverter device, wherein the electrical machine is configured as an N x M phase machine having N times M phases, wherein N is N >= 2 and M is M >= 3, so that M phases connected N-fold in parallel are present, wherein the pulse inverter device comprises one half bridge per phase, wherein the respective half bridge comprises semiconductor switches, wherein the N-fold connection of the phases comprises N half bridges connected in parallel, wherein at least one of the half bridges connected in parallel is or can be switched off. It can thus be achieved, for example, that, in a turndown mode in which the maximum power is not required, with the shutdown of a whole phase, there are reduced switching losses and no transfer losses in the switched-off module or the switched-off half bridge, with only slightly increased conductive losses in the activated power module or in the activated half bridge. This is accompanied by an increase in the efficiency of the electric machine with the pulse inverter device and an increase in the range of the electrically driven motor vehicle.

It is particularly advantageous when the half bridges connected in parallel are switched off per phase during the turndown mode. Thus, the advantages described above are particularly apparent in the turndown mode, wherein the phases are not switched off during a

full-load mode so that the full power of the electric machine can be used while utilizing all available phases.

It is also expedient when the semiconductor switches of the half bridge are switched open when the half bridge is switched off. Thus, parasitic currents in the switched-off state are avoided.

It is also expedient when the turndown mode of the electric machine occurs in a power range below the maximum power of the electric machine and/or in a torque range below the maximum torque of the electric machine, in particular the turndown mode of the electric machine occurs in a power range below 90% of the maximum power of the electric machine and/or in a torque range below 90% of the maximum torque of the electric machine, furthermore in particular the turndown mode of the electric machine occurs in a power range below 80% of the maximum power of the electric machine and/or in a torque range below 80% of the maximum torque of the electric machine. It is thus ensured that the maximum power is available during full-load mode.

It is also expedient when the electric machine is configured such that: N = 2 and M = 3, or N = 3 and M = 3, or N > 3 and M = 3, or N = 2 and M = 4, or N = 3 and M = 4.

In an aspect, the present disclosure provides a motor vehicle having an electric machine for driving the motor vehicle and having a pulse inverter device for supplying and controlling the electric machine, wherein the electric machine and the pulse inverter device are configured according to the invention.

In an aspect, the present disclosure provides a method for operating an electrical machine having a pulse inverter device, wherein the electrical machine is configured as an N x M phase machine having N times M phases, wherein N is N >= 2 and M is M >= 3, so that M phases connected N-fold in parallel are present, wherein the pulse inverter device comprises one half bridge per phase, wherein the half bridge comprises semiconductor switches, wherein the N-fold connection of the phases comprises N half bridges connected in parallel, wherein at least one of the half bridges connected in parallel is switched off per phase, in particular during a turndown mode. It is thus achieved, for example, that, in a turndown mode in which the

maximum power is not required, with the shutdown of a whole phase, there are reduced switching losses and no transfer losses in the switched-off module or the switched-off half bridge, with only slightly increased conductive losses in the activated power module or in the activated half bridge. This is accompanied by an increase in the efficiency of the electric machine with the pulse inverter device and an increase in the range of the electrically driven motor vehicle.

It is also expedient when the semiconductor switches of the half bridge are switched open when the half bridge is switched off.

It is furthermore expedient when the turndown mode of the electric machine occurs in a power range below the maximum power of the electric machine and/or in a torque range below the maximum torque of the electric machine, in particular the turndown mode of the electric machine occurs in a power range below 90% of the maximum power of the electric machine and/or in a torque range below 90% of the maximum torque of the electric machine, furthermore in particular the turndown mode of the electric machine occurs in a power range below 80% of the maximum power of the electric machine and/or in a torque range below 80% of the maximum torque of the electric machine.

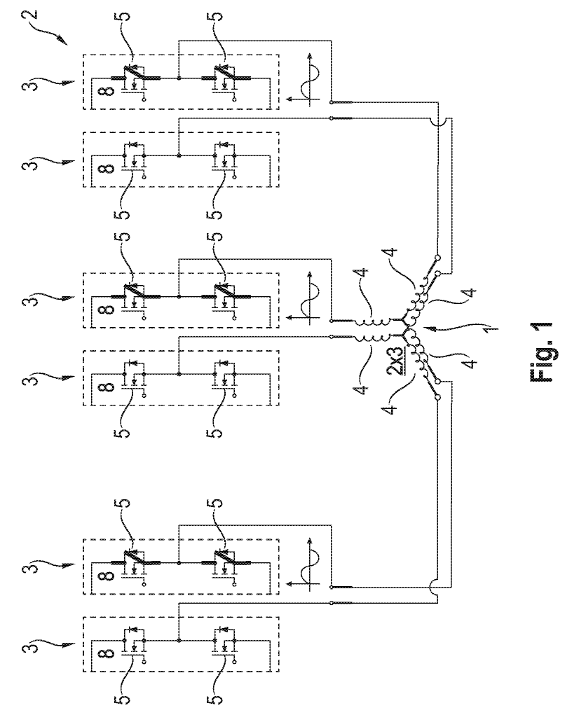

The present disclosure relates to an electric machine 1 having a pulse inverter device (also referred to herein as a pulse inverter) 2, as shown schematically in FIG. 1.

The electrical machine 1 is configured as an N x M phase machine having N times M phases, wherein N is N >= 2 and M is M >= 3, so that M phases connected N-fold in parallel are present. There is no specific limitation for N and M according to the present disclosure.

In the example embodiment shown, N = 2 and M = 3. The electric machine 1 can alternatively also be configured such that: N = 3 and M = 3, or N > 3 and M = 3, or N = 2 and M = 4, or N = 3 and M = 4, etc.

The pulse inverter device 2 comprises one half bridge 3 per phase 4, wherein the half bridge 3 comprises semiconductor switches 5. The N-fold connection of the phases 4 comprises N half bridges 3 connected in parallel, wherein at least one of the half bridges 3 connected in parallel is or can be switched off. In the example embodiment shown in FIG. 1, the half bridges 3

shown on the right are designed so to that they can be switched off. It can also be different, in principle.

It is particularly advantageous when the half bridges 3 connected in parallel are switched off per phase during the turndown mode.

It is particularly advantageous when the semiconductor switches 5 of the half bridge 3 are switched open when the half bridge 3 is switched off.

Because the shutdown of the phases 4 is particularly advantageous in the turndown mode, it is expedient to define the turndown mode. Advantageously and by way of example, a turndown mode of the electric machine 1 occurs in a power range below the maximum power of the electric machine 1 and/or in a torque range below the maximum torque of the electric machine 1. It is also advantageous when the turndown mode of the electric machine 1 occurs in a power range below 90% of the maximum power of the electric machine 1 and/or in a torque range below 90% of the maximum torque of the electric machine 1, furthermore it is also advantageous when the turndown mode of the electric machine 1 occurs in a power range below 80% of the maximum power of the electric machine 1 and/or in a torque range below 80% of the maximum torque of the electric machine 1.

Advantageously, the electric machine 1 is configured for driving the motor vehicle and the pulse inverter device 2 is configured for supplying and controlling the electric machine 1 in a motor vehicle.

From the above description, the method according to an aspect of the present disclosure for operating an electric machine 1 having a pulse inverter device 2 is also explained, wherein the electric machine 1 is configured as an N x M-phase machine with N times M-phases 4, wherein N is N >= 2 and M is M >= 3, so that M phases 4 connected N-fold in parallel are present. The pulse inverter device 2 comprises one half bridge 3 per phase 4, wherein the respective half bridge 3 comprises semiconductor switches 5, wherein the N-fold connection of the phases 4 comprises N half bridges 3 connected in parallel, wherein at least one of the half bridges 3 connected in parallel is or can be switched off per phase 4, for example during a turndown mode. The semiconductor switches 5 of the half bridge 3 are switched open when the half bridge 3 is switched off.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Electric machine 1

Pulse inverter device 2

Half bridge 3

Phase 4

Semiconductor switch 5

1. An electrical machine configured as an N x M phase machine having N times M phases, wherein N is N >= 2 and M is M >= 3, so that M phases connected N-fold in parallel are present, the electric machine comprising a pulse inverter,
wherein the pulse inverter comprises a plurality of half bridges with one half bridge per phase, each of the half bridges comprising semiconductor switches, and the N-fold connection of the M phases comprising N half bridges connected in parallel, and
wherein at least one of the N half bridges connected in parallel is switched off or is capable of being switched off.

2. The electric machine according to claim 1, wherein the half bridges connected in parallel are configured to be switched off per phase during a turndown mode.

3. The electrical machine according to claim 1, wherein, when one of the half bridges are switched off, the semiconductor switches of the half bridge is switched open.

4. The electrical machine according to claim 2, wherein the turndown mode of the electric machine occurs in a power range below a maximum power of the electric machine and/or in a torque range below a maximum torque of the electric machine.

5. The electrical machine according to claim 1, wherein the electrical machine is configured such that N = 2 and M = 3, or N = 3 and M = 3, or N > 3 and M = 3, or N = 2 and M = 4, or N = 3 and M = 4.

6. A motor vehicle comprising the electric machine according to claim 1, the electric machine being configured for driving the motor vehicle and having the pulse inverter for supplying and controlling the electric machine,.

7. A method for operating an electrical machine comprising a pulse inverter , the electrical machine being configured as an N x M phase machine having N times M phases, wherein N is N >= 2 and M is M >= 3, so that M phases connected N-fold in parallel are present, wherein the pulse inverter comprises one half bridge per phase, which comprises semiconductor switches, such that the N-fold connection of the M phases comprises N half bridges connected in parallel, the method comprising:
switching off at least one of the N half bridges connected in parallel per phase during a turndown mode.

8. The method according to claim 7, wherein, when the at least one of the N half bridges is switched off, the semiconductor switches of the half bridge are switched open.

9. The method according to claim 7, wherein the turndown mode of the electric machine occurs in a power range below a maximum power of the electric machine and/or in a torque range below a maximum torque of the electric machine.
